(19) United States
(12) Patent Application Publication
(10) Pub. No.: US 2007/0176329 A1
(43) Pub. Date: Aug. 2, 2007

(54) MAGNETIC FIELD MODLING DEVICE, DIE AND METHOD FOR MAGNETIC FIELD MOLDING

(75) Inventors: Norihisa Saito, Tokyo (JP); Tomohiro Masuda, Tokyo (JP)

Correspondence Address: PEARNE & GORDON LLP, 1801 EAST 9TH STREET, SUITE 1200, CLEVELAND, OH, 44114-3108, US

(73) Assignee: TDK CORPORATION, Tokyo (JP)

(21) Appl. No.: 11/626,395

(22) Filed: Jan. 24, 2007

(30) Foreign Application Priority Data
Feb. 1, 2006 (JP) 2006-024473

(51) Int. Cl. H05B 6/00

(52) U.S. Cl. 264/429; 425/3; 425/DIG. 33

(57) ABSTRACT

The objects of the present invention are to provide a durable magnetic field molding device for producing molded bodies for ferrite magnets, which needs a controlled amount of releasing agent, reduces production cost and improves productivity, and die and magnetic field molding method. The lower die 12B of the die 12 is coated, on the surface which defines the cavity 11, with the coating film 30 with a high hardness and a low friction coefficient, which improves resistance of the lower die 12B surface to wear by the solid component (fine powder) in the slurry, thereby greatly improving durability of the coating film 30 itself and reducing lubricant usage.

### BACKGROUND OF THE INVENTION

1. Field of the Invention

The present invention relates to a magnetic field molding device suitable for wet molding, die and method for magnetic field molding.

2. Description of the Related Art

Ferrite (sintered) magnets, now predominating magnets, are produced from starting material mixture with a given composition, which are calcined into a ferrite, milled to a sub-micron size to produce powder of ferrite particles. The powder is then compression-molded in a die placed in a magnetic field (hereinafter referred to as magnetic field molding) to form a molded body and sintered to produce a ferrite magnet (as disclosed Patent Document 1, for example).

Magnetic field molding processes broadly fall into two categories, dry process and wet process, where the ferrite powder is dried and molded in the former and the slurried powder is molded in the latter.

[Patent Document 1] Japanese Patent Laid-Open No. 2005-317911

### SUMMARY OF THE INVENTION

In the magnetic field molding process, a material powder in dry molding or a slurried powder in wet molding is injected into a die cavity in which the powder is compression-molded into a molded body. It is a general procedure to coat the surface of a die cavity with a releasing agent to prevent sticking of the molded body to the cavity surface.

However, use of a releasing agent may cause chipping or cracking of the molded body to increase percent defective, when its quantity is not adequate.

Moreover, it is necessary to apply a releasing agent periodically on a die cavity, for example, in every shot. This increases releasing agent consumption to cause a higher production cost. Still more, spreading a releasing agent needs time-consuming labor, which also lead to reduced productivity.

In common molding using a die, a die cavity is surface-treated, e.g., by plating, to form a coating film thereon, in order to prevent sticking of a molded body to the cavity surface. Ferrite powder for magnets itself causes problems due to its high hardness. The particles are movable, more noted in wet molding in the presence of a dispersant in the slurry than in dry molding, to severely erode the coating film and greatly reduce die durability. For a ferrite magnet producing die, the mortar-shaped die may be made of a super hard material, and the upper and lower punches may be made of respective stainless steel and Stellite® steel. In the above case, a coating film, when used, is formed on a lower punch of dies steel, which is less hard than a superhard material. When the coating film is worn by the reason described above, the lower die is less durable than an uncoated mortar-shaped die, and is uneconomical. Therefore, it must be said that a coating film formed by a conventional procedure is unpractical for wet magnetic field molding.

Use of a releasing agent is essential even when a coating film is formed, and the above problems cannot be solved by a coating film.

The present invention is developed to solve these technical problems. The objects of the present invention are to provide a durable magnetic field molding device for producing molded bodies for ferrite magnets, which needs a controlled amount of releasing agent, reduces production cost and improves productivity, and die and magnetic field molding method.

The magnetic field molding device of the present invention, developed to achieve the above objects, is a device used for producing ferrite magnets. It comprises a die for compression molding of a slurry of a powder mainly composed of ferrite dispersed in a dispersion medium to form a molded body of given shape; and a magnetic field generating source for applying a magnetic field of given orientation to the slurry in the die, wherein a die cavity surface is coated, at least partly, with a coating film of a material harder than the powder and lower in friction coefficient than a die base material.

Wet molding for producing a ferrite magnet from a slurry needs severer conditions with respect to die and coating film service lives than dry molding. For such a magnetic field molding device for wet molding, a coating film formed on die cavity surface at least partly will have improved resistance to powder when it is made of a material harder than the powder and lower in friction coefficient than a die base material. Moreover, the coating film surface has a low friction coefficient to reduce usage of a releasing agent or the like to be spread on the die cavity surface.

The coating film is preferably at least twice as hard as the powder to assure its effect. For example, it has a Vickers hardness Hv of 3,000 or more and friction coefficient μ of 0.2 or less. The film is preferably made of diamond-like carbon.

The die of the present invention is for producing ferrite magnets, in which a slurry of a powder mainly composed of ferrite dispersed in a dispersion medium is compression-molded to form a molded body of given shape. It comprises a mortar-shaped die provided with a hole having a cross-section of given shape, lower die fit into the mortar-shaped die hole from beneath and upper die provided to face the mortar-shaped die, wherein the lower die is coated, on the upper side, with a coating film of material at least twice as hard as the powder and having a lower friction coefficient than the lower die base material.

The magnetic field molding method of the present invention comprises a step for injecting a slurry of a powder mainly composed of ferrite dispersed in a dispersion medium into a die coated, at least partly, with a material harder than the powder and lower in friction coefficient than a die base material; a step for compressing the slurry in the die, while applying a magnetic field in a given orientation; and a step for opening the die to withdraw the resulting molded body, produced by compression-molding of the slurry, from the die.

The present invention can improve resistance of coating film, which coats a die at least partly, to wear by a ferrite material (powder) in the slurry by using a material of high hardness and low friction coefficient. As a result, the present invention improves durability of the die, reduces releasing agent consumption by virtue of the coating film of low friction coefficient, reduces labor for releasing agent spreading, and thereby improves productivity and reduces production cost.

### BRIEF DESCRIPTION OF THE DRAWINGS

FIG. 1 shows one embodiment of the ferrite magnet production process flow scheme;

FIG. 2 illustrates a magnetic field molding device die structure with a plurality of cavities; and

FIG. 3 is a cross-sectional view illustrating part of a magnetic field molding device.

### DETAILED DESCRIPTION OF THE PREFERRED EMBODIMENTS

The present invention is described in detail by referring to the attached drawings.

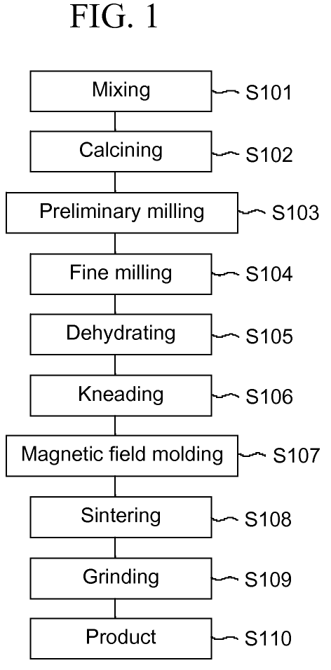

FIG. 1 shows one embodiment of the ferrite magnet production process flow scheme. This figure illustrates only one embodiment of the ferrite magnet production process, and it is needless to say that the process can be altered as required.

As illustrated in FIG. 1, the ferrite magnet production process begins with calcination of a starting material mixture with a given composition into a ferritic state (Steps S101 and S102). Some examples of the starting materials include oxide powders or compounds which can be calcined into an oxide, e.g., carbonate, hydroxide and nitrate powder. The calcination may be generally carried out in an oxidative atmosphere, e.g., in air.

Then, the calcined product is preliminarily milled (Step S103) to produce the powder of calcined ferrite particles. The calcined, powdered product is finely milled, after being incorporated with an additive as required, to a sub-micron size (Step S104) to produce the fine powder, mainly composed of magnetoplumbite type ferrite. The preliminary milling and fine milling may be carried out either by a wet or dry procedure. It is preferable that the preliminary milling is carried out by a dry procedure and fine milling by a wet procedure, because the as-calcined, powdered product is generally composed of granules. In this case, the calcined, powdered product is preliminary milled to a given size or less, and then finely milled to a given size or less, after preparing a slurry including the preliminary milled powder and water.

Then, the finely milled powder is dispersed in a dispersion medium to have a slurry of given concentration, and molded in a magnetic field. The powder, when finely milled by a wet procedure, may be subjected to a dehydration step (Step S105) to concentrate the slurry to a desired concentration.

The dispersion medium may be water, hexane, toluene, p-xylene, methanol or the like.

The slurry is kneaded (Step S106), and injected into a die in which it is compression-molded in a magnetic field of given orientation for magnetic field molding (Step S107).

The resulting molded body is sintered to produce a ferrite magnet (Step S108). It is then formed into a given shape to produce a ferrite magnet as the final product (Steps S109 and S110).

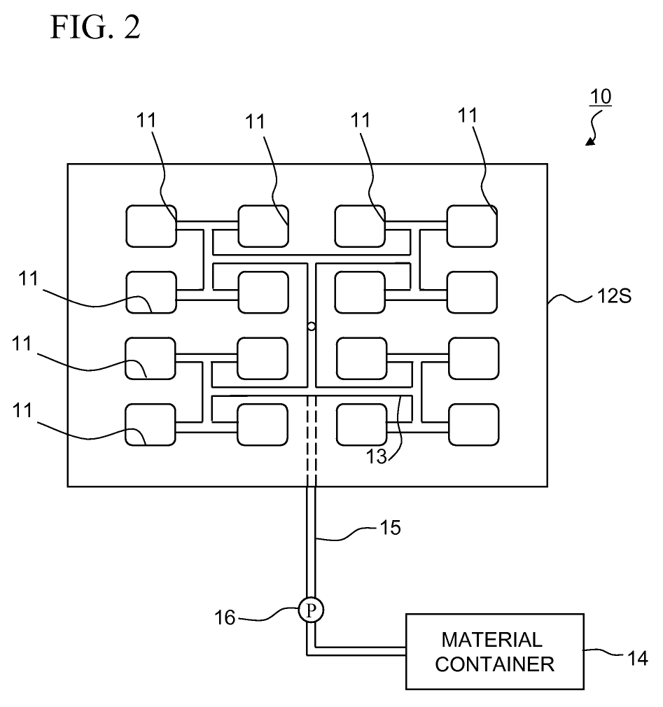

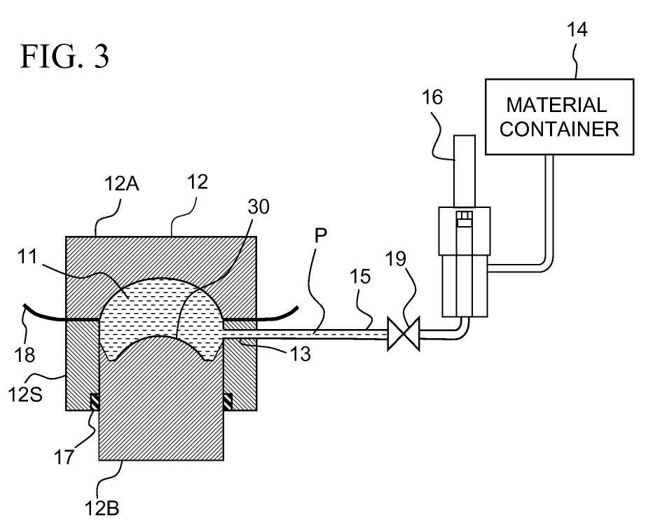

FIGS. 2 and 3 schematically illustrate a magnetic field molding device 10 for the magnetic field molding in the above-described Step S107.

The magnetic field molding device 10 performs compression molding of a slurry adjusted at a given concentration in a magnetic field to orient the ferrite particles in a given direction and thereby to produce a ferrite magnet of given shape. As illustrated in FIG. 2, the magnetic field molding device 10 has a plurality of cavities 11 to produce a plurality of ferrite magnets.

FIG. 3 is a cross-sectional view illustrating the one cavity 11 in the magnetic field molding device 10. As illustrated in FIG. 3, the magnetic field molding device 10 has a die 12 comprising an upper die 12A, lower die 12B and mortar-shaped die 12S. The upper die 12A is provided to face the mortar-shaped die 12S, and the lower die 12B is fit into a hole in the mortar-shaped die 12S from beneath. At least one of the upper die 12A and lower die 12B is movable to draw towards or apart from each other as it driven by a driving cylinder (not shown) or the like as a driving source. In this specific embodiment, the lower die 12B vertically moves to or away from the upper die 12A at given strokes.

The mortar 12S may be stationary or vertically movable.

As illustrated in FIG. 2, the mortar 12S is provided with an injection path 13 for injecting a slurry into the individual cavity 11. The injection path 13 distributes and injects the slurry supplied from a material container 14 using a pump 16 into the individual cavity 11 through a material supply tube 15.

As illustrated in FIG. 3, the individual lower die 12B performs compression molding of the slurry into a given shape in the cavity 11 at the stroke end. The mortar-shaped die 12S is provided with a sealing member 17 which seals the gap between the mortar-shaped die 12S and lower die 12B.

A filter cloth 18 is placed between the mating surfaces of the upper die 12A and mortar-shaped die 12S to remove water in the slurry from the cavity 11. Water in the slurry slips through the filter cloth 18 from the mating surfaces of the upper die 12A and mortar-shaped die 12S to the outside. This dehydrates the slurry.

A magnetic field generating source (not shown), e.g., a magnetic field generating coil or the like, is provided in the vicinity of the upper die 12A, to apply a magnetic field of given orientation to the slurry.

For the die 12, the upper die 12A was made of stainless steel, the lower die 12B of Stellite steel and the mortar-shaped die 12S of a superhard material.

A coating film 30 is formed in the lower die 12B on a portion which forms an inner peripheral surface of the cavity 11. The coating film 30 has a higher hardness than the finely milled powder, particularly preferably at least 2 times higher. In this embodiment, the coating film 30 preferably has a Vickers hardness Hv of 1,600 or more, more preferably 2,000 or higher, particularly preferably 3,000 or more, given that the finely milled powder has an Hv value of around 800. It preferably has as low a friction coefficient as possible. More specifically, it preferably has a friction coefficient μ of 0.2 or less. The materials for the coating film 30 satisfying the above conditions include hard carbon-based materials, which may be incorporated with an element, e.g., phosphorus, silicon, tungsten, chromium or the like. Diamond-like carbon, which can give a film having an Hv value of 3,000 or more and μ value of 0.2 or less, is a particularly preferable hard, carbon-based material for the coating film 30. A coating film of diamond-like carbon is formed by bombarding an object to be coated (lower die 12B in this embodiment) with ions in a plasma, produced by decomposing a hydrocarbon gas by an arc-discharge plasma under a high vacuum. It has a dense amorphous structure, very flat, smooth surfaces free of grain boundaries and has a notably higher hardness and lower friction coefficient than a coating film of CrN, TiN, TiCN, TiCrN or the like, known to have similarly high hardness and low friction coefficient.

The magnetic field molding device 10 of the structure described above distributes and supplies the slurry into the individual cavity 11 defined by the upper die 12A and lower die 12B, where the slurry is kneaded in Step S106 and supplied by the pump 16 from a material container 14 through the material supply tube 15 and injection path 13.

A magnetic field generated by a magnetic field generating coil (not shown) or the like is applied to the slurry being injected into the cavity 11. A shutoff valve 19 is closed when the cavity 11 is filled with a given quantity of the slurry, which closes a system P on the die 12 side from the shutoff valve 19, i.e., the system which includes the cavity 11, injection path 13 and material supply tube 15 downstream of the shutoff valve 19. Then, the lower die 12 is operated and a given pressure is applied to the slurry held between the upper die 12A and lower die 12B. Water in the slurry is discharged to the outside after slipping through the filter cloth 18. Pressure generated in the cavity 11 is propagated to the slurry held in the injection path 13 and material supply tube 15.

The slurry is compressed between the upper die 12A and lower die 12B to a maximum level, at which it is held for a given time, during which the solid component of the slurry in the cavity 11 is formed into a given shape while a magnetic field is applied.

Then, the upper die 12A and lower die 12B are opened to release the molded body formed into a given shape.

The lower die 12B has been coated, on the surface which defines the cavity 11, with the film 30 of high hardness and low friction coefficient, which improves resistance of the lower die 12B surface to wear by the solid component (fine powder) in the slurry. The improved wear resistance of the lower die 12B surface brings a significant effect, because of vigorous motion of the solid component in the slurry, more noted in a portion where the upper die 12A/lower die 12B distance ratio, i.e., filling ratio (cavity depth before slurry charging/molded body thickness after compression (molding)) varies greatly before and after the compression.

The improved surface wear resistance characteristics of the lower die 12B, brought by the coating film 30, greatly improves durability of the coating film 30 itself. This, in turn, improves durability of the lower die 12B, and can assure durability of the mortar-shaped die 12S of superhard material, which does not have a coating film 30. At the same time, the coating film 30 of low friction coefficient can reduce releasing agent usage, possibly to zero. This reduces releasing agent consumption and spreading labor, and thereby to improve productivity and reduce production cost.

As discussed above, the coating film 30 can greatly improve economic efficiency.

### EXAMPLES

The effects brought by the coating film 30 have been confirmed, and the results are described below.

### Examples

A slurry was prepared by the process illustrated in FIG. 1. A ferrite material (finely milled powder) used in the slurry was strontium ferrite (Vickers hardness Hv: 800), which was dispersed in water as a dispersion medium. The slurry was injected into the disc-shape cavity 11 (diameter: 30 mm) individually by the pump 16 working at a constant pressure.

When the cavity 11 was filled with a given quantity of the slurry, the shutoff valve 19 was closed to close the system P. Then, the slurry was compressed while the upper die 12A and lower die 12B were kept closed. Then, the upper die 12A and lower die 12B were opened, and the resulting molded body was withdrawn.

The upper surface of the lower die 12B had been coated with the coating film 30 of diamond-like carbon. A total of four types of the film were formed, each having a Vickers hardness Hv of 800, 850, 1,600 or 3,200 (Comparative Example 2 and Examples 1 to 3). The coating film 30 was 1 μm thick and had a friction coefficient μ of the coating film 30 of 0.1 in each case. The lower die 12B was not coated with the coating film 30 in Comparative Example 1 for comparison (Comparative Example 1).

The magnetic field molding described above was repeated on the lower die 12B in each of Examples 1 to 3 and comparative Examples 1 and 2. In Comparative Example 1, a releasing agent was spread on the surface of the lower die 12B in every shot. In Examples 1 to 3 and Comparative Example 2, it was spread as required on the surface of the lower die 12B every time it was depleted.

First, the durability of the coating film 30 prepared in each of Examples 1 to 3 and Comparative Example 2 was evaluated. The coating film service life is defined by S1/S2 ratio, where S1 is a shot number when the film 30 was worn to expose the lower die 12B base material, and S2 is ultimate serviceable shot number of the mortar-shaped die 12S of a superhard material (which was determined by the inside dimensions of mortar-shaped die 12S and the like).

The results are given in Table 1, which shows that the coating film 30 having the same Vickers hardness (Hv: 800) as the ferrite material in the slurry, prepared in Comparative Example 2, had a service life of 0.01, whereas the one having a Vickers hardness Hv of 850, prepared in Example 1, had an almost 10 times longer service life of 0.1. The one prepared in Example 2 to have an Hv value of 1,600 had a 50 times longer service life, and the one prepared in Example 3 to have an Hv value of 3,200 had such a long service life comparable to, or longer than, that of the mortar-shaped die 12S.

TABLE 1

| | Coating | Coating | | | | | |
|---|---|---|---|---|---|---|---|
| | film | film | Releasing | | Die | | Releasing |
| | hardness | service | agent | Percent | cleaning | Detergent | agent |
| | (Hv) | life | usage | defective | time | usage | usage |
| Comparative | — | — | 1 | 1.25 | 1 | 1 | 1 |
| Example 1 | | | | | | | |
| Comparative | 800 | 0.01 | 1 | 1.25 | — | — | — |
| Example 2 | | | | | | | |
| Example 1 | 850 | 0.1 | 0.95 | 1.1 | — | — | — |
| Example 2 | 1600 | 0.5 | 0.72 | 0.65 | — | — | — |
| Example 3 | 3200 | 1 or | 0.44 | 0.05 | 0.45 | 0.44 | 0.44 |
| | | longer | | | | | |

The coating film 30 preferably has a hardness higher than that of the ferrite material in the slurry, viewed from its service life or prevention of wear, more preferably at least 2 times higher, particularly preferably at least 4 times higher, or an Hv value of 3,000 or more in this embodiment.

Releasing agent usage was evaluated by that needed for 1000 shots of the magnetic field molding, relative to that observed in Comparative Example 1.

The results shown in Table 1 indicate that the releasing agent usage decreased as hardness of the coating film 30 increased. It is particularly noted that the usage decreased by almost 30% in Example 2 which prepared the coating film 30 having an Hv value of 1,600, and to such a very low level below half in Example 3 which prepared the coating film 30 having an Hv value of 3,200.

Possibility of cracking or the like in the molded body should decrease as releasing agent usage decreases. Therefore, the molded bodies prepared were sintered to observe percent defectives caused by cracking or chipping after sintering.

As a result, it was observed that releasing agent usage showed a trend similar to that of percent defective. Percent defective decreased as hardness of the coating film 30 increased. It was almost halved with the coating film prepared in Example 2 to have an Hv value of 1,600, and decreased to as low as nearly zero with the one prepared in Example 3 to have an Hv value of 3,200.

As described above, it is confirmed that increasing hardness of the coating film 30 on the lower die 12B decreases releasing agent usage and percent defective, and thereby brings favorable effects, e.g., reduced production cost and improved productivity.

The results observed in Example 3 which prepared the die with the coating film 30 are compared, with respect to releasing agent usage, cleaning time needed for cleaning the die 12 and detergent usage for one shot, with those observed in Comparative Example 1 which prepared an uncoated die.

As a result, it is confirmed, as shown in Table 1, that each of releasing agent usage, cleaning time and detergent usage with the coated die is less than half that with the uncoated die. It is considered that these favorable effects result from decreased sticking of the ferrite material in the slurry to the lower die 12B by virtue of improved hardness and reduced friction coefficient of the lower die 12B surface coated with the coating film 30.

What is claimed is:

1. A magnetic field molding device for producing ferrite magnets, comprising:
a die for compression molding of a slurry of a powder mainly composed of ferrite dispersed in a dispersion medium to form a molded body of a given shape, and
a magnetic field generating source for applying a magnetic field of a given orientation to the slurry in the die,
wherein a die cavity surface is coated, at least partly, with a coating film of a material harder than the powder and lower in friction coefficient than a die base material.

2. The magnetic field molding device according to claim 1, wherein the coating film is at least twice as hard as the powder.

3. The magnetic field molding device according to claim 1 or 2, wherein the coating film has a Vickers hardness Hv of 3,000 or more and a friction coefficient μ of 0.2 or less.

4. The magnetic field molding device according to claim 3, wherein the coating film is made of diamond-like carbon.

5. The magnetic field molding device according to claim 1, wherein the coating film is formed on a portion which forms an inner peripheral surface of the die cavity.

6. A die for producing ferrite magnets, in which a slurry of a powder mainly composed of ferrite dispersed in a dispersion medium is compression-molded to form a molded body of a given shape, comprising:
a mortar-shaped die provided with a hole(s) having a cross-section of a given shape,
a lower die fit into the mortar-shaped die hole from beneath, and
an upper die provided to face the mortar-shaped die,
wherein the lower die is coated, on the upper side, with a coating film of a material at least twice as hard as the powder and having a lower friction coefficient than a lower die base material.

7. The die according to claim 6, wherein the coating film has a Vickers hardness Hv of 3,000 or more.

8. The die according to claim 6, wherein the coating film has a friction coefficient μ of 0.2 or less.

9. The die according to claim 6, wherein the coating film is made of diamond-like carbon.

10. The die according to claim 6, wherein the mortar-shaped die is made of a superhard material.

11. The die according to claim 6, wherein the upper die is made of stainless steel.

12. The die according to claim 6, wherein the lower die is made of Stellite® steel.

13. A magnetic field molding method comprising the steps of:
injecting a slurry of a powder mainly composed of ferrite dispersed in a dispersion medium into a die coated, at least partly, with a coating film of a material harder than the powder and lower in friction coefficient than a die base material,
compressing the slurry in the die, while applying a magnetic field of a given orientation to the slurry, and
opening the die to withdraw the resulting molded body, produced by compression-molding of the slurry, from the die.

14. The magnetic field molding method according to claim 13, wherein the coating film is made of diamond-like carbon.

15. The magnetic field molding method according to claim 13, wherein the powder is strontium ferrite and the coating film has a Vickers hardness Hv of 3,000 or more and a friction coefficient μ of 0.2 or less.
